(19) United States
(12) Patent Application Publication
(10) Pub. No.: US 2015/0027331 A1
(43) Pub. Date: Jan. 29, 2015

(54) METHOD AND DEVICE FOR PRODUCING A PRINTING FORME AND PRINTING METHOD

(71) Applicant: Manroland web systems GmbH, Augsburg (DE)

(72) Inventor: Florian FEJFAR, Munich (DE)

(73) Assignee: Manroland web systems GmbH, Augsburg (DE)

(21) Appl. No.: 14/340,878

(22) Filed: Jul. 25, 2014

(30) Foreign Application Priority Data
Jul. 26, 2013 (DE) 10 2013 107 996.2

(51) Int. Cl. B41F 7/02

(52) U.S. Cl. CPC B41F 7/025
USPC 101/450.1; 101/453

(57) ABSTRACT

A method for producing printing formes, which serve for the printing of a substrate web with a seamless or transitionless, endless or format-variable print image in offset print, is disclosed. For each printing color of the print image to be printed, a total separation of the respective printing color is divided over at least two printing formes so that with a first printing forme a first part separation of the total separation and with a second printing forme a second part separation of the total separation can be printed onto the substrate web. The substrate web in first portions can be exclusively printed by the first part separation and in second portions can be exclusively printed by the second part separation. The substrate web in third portions can be printed by the first part separation and by the second part separation in an overlapping or overlaying manner.

This application claims the priority of German Patent Document No. DE 10 2013 107 996.2, filed Jul. 26, 2013, the disclosure of which is expressly incorporated by reference herein.

### BACKGROUND AND SUMMARY OF THE INVENTION

The invention relates to a method for producing printing formes, which serve for the printing of a substrate web with a seamless or transitionless endless or format variable print image by offset printing. The invention furthermore relates to a device for producing such printing formes and a method for producing a substrate web with a seamless or transitionless endless or format variable print image, which is put together from at least two printing formes, in offset print using such printing formes.

There is an increasing need for the printing of a substrate web with a seamless or transitionless endless print image, in order to, for example, produce packages, wallpaper or gift wrap papers.

In offset print, the printing of a substrate web with a seamless or transitionless endless or format-variable print image has been possible only to an inadequate degree up to now, since for offset printing printing formes are used, which have a defined length and/or in addition to this a print-free region, which for the device for fastening the printing forme on the printing forme cylinder, usually called a clamping slot, and accordingly leave a print-free region behind on the substrate during printing. Accordingly, if in offset print using printing formes which have a limited length and/or a print-free region, seamless, endless or format-variable printing is to be performed, a total separation of the respective printing ink has to be divided over at least two printing formes for each printing color of the printing ink to be printed, so that with a first printing forme a first part separation of the total separation of the respective printing ink and with a second printing forme a second part separation of the total separation of the printing color can be printed onto the substrate.

Here it is provided according to practice that the second part separation of the second printing forme prints in those regions or portions of the substrate web to be printed which cannot be printed with the first part separation of the first printing forme as a consequence of the limited length of the same. The second part separation of the second printing forme accordingly fills up the first part separation of the first printing forme in the regions in which the first part separation of the first printing forme cannot print the substrate. As a consequence of, for example, register errors, this is possible, however, only to an insufficient degree so that in offset print a seamless or transitionless endless or format-variable print is only possible to a limited degree. There is therefore a need for printing formes which in offset print permit seamless or endless printing without substantial quality restrictions.

Starting out from this, the present invention is based on the object of creating a new type of method and a corresponding device for producing printing formes, which serve for the printing of a substrate web with a seamless endless or format-variable print image in offset print and a corresponding method for printing a substrate web with a seamless endless or format-variable print image in offset print.

According to the invention, the total separation of the respective printing ink is divided over the part separations in such a manner that the substrate web in first portions can be exclusively printed by the first part separation of the first printing forme, in that the substrate web in second portions can be exclusively printed by the second part separation of the second printing forme and in that the substrate web in third portions can be printed by the first part separation of the first printing forme and by the second part separation of the second printing forme in an overlapping or overlaying manner.

With the invention present here it is provided to keep ready multiple printing formes for printing each printing color to be printed, wherein the total separation of each printing color is divided over multiple part separations and thus multiple printing formes namely in such a manner that between the part separations there is no hard or sharp transition edge but printing is rather performed with the part separations of the printing formes in an overlapping or overlaying manner. Thus, the total separation of each printing color is divided over the part separations in such a manner that the substrate web in the first portions can be exclusively printed by the first part separation of the first printing forme and in second portions exclusively by the second part separation of the second printing forme, wherein however in third portions the substrate web can be printed with the first part separation of the first printing forme and the second part separation of the second printing forme in an overlapping or overlaying manner. Because of this, seamless endless or format-variable printing in offset printing can be performed with high quality.

In this connection, the definition of an area component is introduced. This is the division of the print image of the at least two printing formes involved in the printing process. Thus, the area component as a rule is between 0% and 100%, since a division of a printing or image dot over at least two printing formes involved in the print could otherwise lead to a change of the visual impression compared with a print image which is not divided and thus not result in an identical visual reproduction of the original print image.

According to an advantageous development of the invention, the total separation of the respective printing color is divided over the part separations in such a manner that the first part separation in the first portions of the substrate web provides 100% area component of the respective area coverage for the respective printing color, that the second part separation in the second portions of the substrate web provides 100% area component of the respective area coverage for the respective print color, and that for the third portions of the substrate web the first part separation provides a position-dependent first area component of the respective area coverage and the second part separation a position-dependent second area component of the respective area coverage. This advantageous further development of the invention allows high-quality printing of print products and with a seamless endless or format-variable print image in offset print.

Preferentially, the total separation of the respective printing color is divided over the part separations of the respective printing color in such a manner that in the third portions of the substrate web with the first area component of the first part separation and the second area component of the second part separation in total more than 100% area component of the respective area coverage of the respective printing color can be printed on to the substrate in at least some positions of the third portions of the substrate web in an overfilling manner. Alternatively, the total separation of the respective printing color is divided over the part separations of the respective printing color in such a manner that in the third portions of the substrate web with the first area component of the first part separation and the second area component of the second part separation in total 100% area component of the respective area coverage of the respective printing color can be printed onto the substrate in the third portions of the substrate web with the first area component of the first part separation and the second area component of the second part separation. In particular when in the third portions of the substrate web the two part separations are configured in such a manner that with the same overfilling printing can be performed in the third portions, a high-quality seamless endless or format-variable print can be realized in offset print.

According to an advantageous further development of the invention, the total separation of the respective printing color is divided over the part separations of the respective printing color in such a manner that with the help of a tonal value correction during the overlaying of the two part separations tonal value fluctuations to be expected are compensated, wherein the tonal value correction is performed dependent on the degree of the overlaying of the two part separations. With the tonal value correction, a further quality increase during the seamless endless or format-variable printing in offset print is possible.

Preferred further developments of the invention are obtained from the following description.

### DETAILED DESCRIPTION OF INVENTION

The invention relates to a method for producing printing formes, which serve for the printing of a substrate web with a seamless, endless or format-variable print image in offset print. The invention furthermore relates to a device for printing such printing formes and to a method for printing a substrate web with a seamless or transitionless endless or format-variable print image in offset print making use of such printing formes.

For each printing color to be applied onto the substrate during the seamless or transitionless endless or format-variable printing, the total separation of the respective printing color is divided over at least two printing formes, so that with a first printing forme a first part separation of the total separation of the respective printing color and with a second printing forme, a second part separation of the total separation of the respective printing color can be printed onto the substrate.

The total separation of the respective printing color according to the invention in this case is divided over the part separations in such a manner that the substrate web in first portions can be exclusively printed by the first part separation of the first printing forme, that the substrate web in the second portions can be exclusively printed by the second part separation of the second print forme, and that the substrate web in third portions can be printed by the first part separation of the first printing forme and the second part separation of the second printing forme in an overlapping or overlaying manner, so that between the part separations of each printing color there is no hard, edge-like transition but rather, a soft, merging transition in the print image.

In particular, the total separation of the respective printing color is divided over the part separations during the production of the offset printing formes in such a manner that with the first part separation in the first portions the substrate web for the respective printing color 100% area component of the respective area coverage of the respective printing color can be printed onto the substrate web, that with the help of the second part separations in the second portions of the substrate web for the respective printing color, 100% area component of the respective area coverage of the respective printing color can be printed onto the substrate web, and that in the third portions of the substrate web with the first part separation a position-dependent first area component of the respective area coverage and with the second part separation a position-dependent second area component of the respective area coverage of the respective printing color can be printed onto the substrate web.

Here it can be provided that in the third portions of the substrate web with the first area component of the first part separation and the second area component of the second part separation in each position of the third portions of the substrate web in total 100% area component each of the respective area coverage of the respective printing color is printed onto the substrate.

However, preferred is a configuration in which the total separation is divided over the part separations in such a manner that in the third portions of the substrate web that with the first area component of the first part separation and the second area component of the second part separation in at least some positions, preferentially in each position, of the third portions of the substrate web in total more than 100% area component of the respective area coverage of the respective printing color can be printed onto the substrate in an overfilling manner, since because of this a particularly advantageous, high-quality seamless or transitionless endless or format-variable printing of the substrate web in offset print is possible.

From the above relationships it follows, accordingly, that the substrate web in the first portions is exclusively printed by the first part separation of the first printing forme. In the second part portions of the substrate web, the latter is exclusively printed by the second part separation of the second printing forme. In the third portions of the substrate web, the same is printed in an overlapping or overlaying manner by both part separations of the two printing formes, namely preferentially in an overfilling manner.

The total separation of the respective printing color in this case is preferentially divided over the part separations of the respective printing color in such a manner that in the third portions of the substrate web, in which overlapping or overlaying printing is performed with both part separations, the position-dependent first area component of the first part separation of the respective area coverage and the position-dependent second area component of the second part separation of the respective area coverage is depicted via a gradient, so that the area components then change continuously as a function of the gradient.

Thus it can be provided that the total separation of the respective printing color is divided over the part separations of the respective printing color in such a manner that in the third portions of the substrate web starting out from the first portions of the substrate web in the direction of the second portions of the substrate web the area component of the first part separation decreases from a first component to a second component and the area component of the second part separation increases from the second component to the first component, whereas in the third portions of the substrate web starting out from the second portions of the same in the direction of the first portions of the same, the area component of the second part separation decreases from the third component to the second component and the area component of the first part separation increases from the second component to the first component. The first component usually amounts to 100%, but can for example be configured also smaller than 100%, for example 80% depending on the subject, substrate etc. The second component usually amounts to 0%, but can also be embodied greater than 0%, for example up to 20% as a function of the subject and/or substrate without configuring the transition visually detectable. These transitions are preferentially configured continuously, for example in the form of a linear or parabolic or other gradient.

According to an advantageous further development of the invention it is provided to divide the total separation of the respective printing color over the part separations of the respective printing color in such a manner that with a tonal value correction during the overlaying of the two part separations tonal value fluctuations to be expected in the print are compensated, wherein the tonal value correction takes place dependent on the print of the overlaying of the two part separations.

Thus, it can be provided according to a first alternative for the tonal value correction of tonal value fluctuations that for the first portions and the second portions of the substrate web, in which the part separations are not overlayed, no tonal value correction is carried out, that by contrast for the third portions of the substrate web, in which the part separations are overlayed during printing, a position-dependent tonal value correction is carried out, namely in such a manner that the tonal value correction in the form of a tonal value increase is greatest in such positions of the third portions in which the area components of the part separations is most alike. Preferentially, the tonal value increase in such positions is the greatest in which both part separations each provide approximately 50% of area component of the respective area coverage of the respective printing color.

According to an alternative, the tonal value correction can be carried out in such a manner that for the first and second portions, in which the part separations are not overlayed, a tonal value reduction takes place. For the third portions, in which the part separations are overlayed, a position-dependent tonal value reduction is carried out namely in such a manner that the tonal value reduction is smallest in such positions in which the area components of the part separations are most alike.

According to a particularly advantageous configuration of the invention, the offset printing formes for the seamless or transitionless, endless or format-variable printing of a substrate web are produced in such a manner that for each printing color to be printed a total separation of the respective printing color is provided, which is greater than the circumferential extension of the forme cylinders, on which the printing formes have to be placed for the printing.

Preferentially, the circumferential extension of the total separation of the respective printing color is approximately 50% longer than the cylinder circumference of the forme cylinders. The total separation then has at its disposal a length which corresponds to 150% of the cylinder circumference of the forme cylinders used for printing.

According to a further particularly advantageous configuration of the invention, the distribution of the area components of the total separation over the part separations takes place according to the screen of the total separation. If the part separations are printed register-correctly it is thus guaranteed that the used screen system including the local position of the screen dots relative to one another is retained without restriction in the print image of the finished print product despite distribution of the total separation over part separations. The screened total separation of each printing color is stored. The screened total separation forms a primary screen.

In an advantageous configuration of the invention, the total separation of each printing color is screened to a so-called primary screen, wherein in this case a non-periodical screening or a periodical screening can be employed.

Preferentially, a tonal value correction is effected prior to the screening of the as yet unscreened total separation namely as described above for compensating for tonal value fluctuations which form during the overlaying of the part separation during printing. This tonal value correction is preferentially performed weighted dependent on location, wherein the tonal value correction preferentially has its maximum effect in those regions of the part separations, in which the part separations develop the maximum overlaying in the print. According to an advantageous configuration, a so-called alpha channel is utilized for this tonal value correction in order to mask the as yet unscreened total separation of the respective printing color for the tonal value correction. The suitably tone-value-corrected total separation is subsequently screened in turn subject to forming the primary screen.

According to the advantageous configuration, the screened total separation of each printing color is subsequently divided into screened part separations for the respective printing color with the help of a secondary screen, the screen frequency of which is lower than the screen frequency of the primary screen or its dot size greater than the dot size of the primary screen. For this purpose, a so-called overlaying mask is initially preferentially provided, which defines the overlaying or overlapping of the part separations in the third portions, wherein this overlaying mask is screened subject to forming the secondary screen, namely via a non-periodical or a periodical screening.

Primary screen and secondary screen can each be both periodical or both non-periodical. In particular when both screens are periodical, the screen frequency of the primary screen is higher than the screen frequency of the secondary screen. Furthermore, the primary screen can be periodical and the secondary screen non-periodical or conversely the primary screen can be non-periodical and the secondary screen periodical. In each case, the secondary screen is coarser than the primary screen.

For creating the first part separation, the primary screen is overlayed with the secondary screen, preferentially erased. For creating the second part separation, the primary screen is overlayed with the inverted secondary screen, in particular erased. Following this, the two screen part separations for the respective printing color are present, which have the length of the total separation.

The length of the part separations is subsequently limited to the length of the circumferential extension of the printing formes, namely preferably in such a manner that in particular when the length of the total separation is 50% larger than the circumferential extension of the forme cylinders used for printing, both part separations are each shortened by a third compared with the total separation, namely the first part separation based on a first end of the total separation and the second part separation based on an opposite second end of the total separation.

The part separations for each printing color so provided are used in the following for exposing the printing plates in order to finally provide the printing plates for the seamless or transitionless, endless or format-variable offset print.

Although the above described sequence of the individual steps for producing the offset printing formes for the seamless or transitionless, endless or format-variable printing of a substrate web is preferred, the sequence of the individual steps can also be varied. Thus, the tonal value correction can be performed before the screening of the total separation of the respective printing color or even after the screening of the total separation of the respective printing color.

It is possible, furthermore, during the formation of the part separations, to limit the primary screen prior to the overlaying with the secondary screen or inverted secondary screen in the length to the length of the circumferential extension of the printing forme to be produced.

The printing formes produced with the help of the method according to the invention are typically printing plates, which for the free printing of a substrate web with a seamless or transitionless, endless or format-variable print image, are positioned on corresponding forme cylinders of a reel-fed printing press.

The printing formes, which print the substrate in a overlaying or overlapping manner for each printing color, in this case are preferentially arranged on forme cylinders, which print rotated by 180° with respect to one another, in which the clamping slots for receiving the printing plates are thus offset by 180° with respect to one another. Using the printing formes produced according to the invention, a substrate web can be printed with a high quality in a seamless or transitionless, endless or format-variable manner.

The device for producing the offset printing formes making use of the method according to the invention is a prepress device, which comprises means for the automatic or automated carrying-out of the method, namely function modules implemented on the software side, with the help of which the total separation of each printing color in the manner described above can be divided over the part separations automatically or automatedly.

As already explained above, the total separation which accordingly is divided for each printing color over part separations is again complemented to form the total separation, so that a seamless or endless print product during printing is obtained. The transition between the part separations is overlapping, i.e., not hard in the sense of a smooth or stepped edge which is visually discernible later on in the case of register deviations, but rather soft merging into one another. Because of this, high-quality seamless or transitionless, endless or format-variable printing can be performed with offset printing.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing printing formes which serve for printing of a substrate web with a seamless or transitionless, endless or format-variable print image in offset printing, comprising:
for each printing color of the print image to be printed, dividing a total separation of the respective printing color over at least two printing formes such that, with a first printing forme a first part separation of the total separation of the respective printing color is printable onto the substrate web, and with a second printing forme a second part separation of the total separation of the respective printing color is printable onto the substrate web;
wherein the total separation of the respective printing color is divided over the part separations such that:
the substrate web in first portions is exclusively printable by the first part separation of the first printing forme;
the substrate web in second portions is exclusively printable by the second part separation of the second printing forme; and
the substrate web in third portions is printable by the first part separation of the first printing forme and by the second part separation of the second printing forme in an overlapping or overlaying manner.

2. The method according to claim 1:
wherein the total separation of the respective printing color is divided over the part separations such that the first part separation for the first portions of the substrate web for the respective printing color provides approximately 100% area component of the respective area coverage;
wherein the second part separation for the second portions of the substrate web for the respective printing color provides approximately 100% area component of the respective area coverage;
and wherein for the third portions of the substrate web the first part separation provides a position-dependent first area component of the respective area coverage and the second part separation provides a position-dependent second area component of the respective area coverage.

3. The method according to claim 2, wherein the total separation of the respective printing color is divided over the part separations of the respective printing color such that in the third portions of the substrate web with the first area component of the first part separation and the second area component of the second part separation in total maximally 100% area component of the respective area coverage of the respective printing color is printable onto the substrate web in each position of the third portions of the substrate web.

4. The method according to claim 2, wherein the total separation of the respective printing color is divided over the part separations of the respective printing color such that in the third portions of the substrate web with the first area component of the first part separation and the second area component of the second part separation in total more than 100% area component of the respective area coverage of the respective printing color is overfillingly printable onto the substrate web in at least some positions of the third portions.

5. The method according to claim 2, wherein the total separation of the respective printing color is divided over the part separations of the respective printing color such that for the third portions of the substrate web the position-dependent first area component of the first part separation of the respective area coverage and the position-dependent second area component of the second part separation of the respective area coverage is each formed via a gradient.

6. The method according to claim 2, wherein the total separation of the respective printing color is divided over the part separations of the respective printing color such that in the third portions of the substrate web starting out from the first portions of the substrate web in a direction of the second portions of the substrate web the area component of the first part separation decreases from a first component to a second component and the area component of the second part separation increases from the second component to the first component, wherein in the third portions of the substrate web starting out from the second portions of the substrate web in a direction of the first portions of the substrate web the area component of the second part separation decreases from the first component to the second component and the area component of the first part separation increases from the second component to the first component.

7. The method according to claim 6, wherein the first component is in a range from 80% to 100% and the second component in a range from 20% to 0%.

8. The method according to claim 2, wherein the total separation of the respective printing color is divided over the part separations of the respective printing color such that with a tonal value correction, tonal value fluctuations which are expected during the overlaying of the two part separations during printing is compensated for, wherein the tonal value correction is dependent on a degree of the overlaying of the two part separations.

9. The method according to claim 8, wherein for the first and second portions, in which the part separations are not overlayed, no tonal value correction is carried out, and wherein for the third portions, in which the part separations are overlayed, a position-dependent tonal value correction is carried out such that a tonal value increase is greatest in such positions of the third portions in which the area components of the part separations are most alike.

10. The method according to claim 8, wherein for the first and second portions, in which the part separations are not overlayed, a tonal value reduction is carried out, and wherein for the third portions, in which the part separations are overlayed, a position-dependent tonal value reduction is carried out such that the tonal value reduction is smallest in such positions of the third portions in which the area components of the part separations are most alike.

11. The method according to claim 1, wherein:
a) for each printing color to be printed a total separation of the respective printing color is provided, a length of which is greater than a circumferential extension of forme cylinders, on which the printing formes for printing are to be placed;
b) the total separation of each printing color to be printed is screened to form a primary screen;
c) the primary screen of each printing color to be printed is divided with a secondary screen, a screen frequency of which is greater than a screen frequency of the primary screen, into screened part separation for the respective printing color, wherein for creating the first part separation the primary screen is overlayed with the secondary screen, and wherein for creating the second part separation the primary screen is overlayed with an inverted secondary screen; and
d) the length of the part separations is limited maximally to a length of the circumferential extension of the printing formes, wherein at least one part separation is also shorter than the length of the circumferential extension of the printing formes.

12. The method according to claim 11, wherein before screening of the total separation to form the primary screen an unscreened total separation is subjected to a tonal value correction such that tonal value fluctuations to be expected through the overlaying of the part separations in the print image are compensated.

13. The method according to claim 11, wherein the length of the total separation is approximately 50% greater than the circumferential extension of forme cylinders on which the printing formes for printing are to be placed, and wherein both part separations compared with the total separation are shortened approximately by ⅓ each.

14. A device for producing printing formes which serve for the printing of a substrate web with a seamless or transitionless, endless or format-variable print image in offset print, comprising means for automated carrying out of the method according to claim 1.

15. A method for printing a substrate web, comprising,
dividing a total separation of a printing color over at least two printing formes such that a first part separation of the total separation of the printing color is provided on a first printing forme and a second part separation of the total separation of the printing color is provided on a second printing forme;
exclusively printing the substrate web in a first portion by the first part separation of the first printing forme;
exclusively printing the substrate web in a second portion by the second part separation of the second printing forme; and
printing the substrate web in a third portion by the first part separation of the first printing forme and by the second part separation of the second printing forme in an overlapping or overlaying manner.
